(19) United States
(12) Patent Application Publication
(10) Pub. No.: US 2010/0317316 A1
(43) Pub. Date: Dec. 16, 2010

(54) System and Method for Providing Mobility and Multi-Purpose Assistance Within a Limited Coverage Area

(75) Inventor: Dimitrios Lalos, St. Charles, IL (US)

Correspondence Address: BARNES & THORNBURG LLP, One NOrth Wacker Drive, CHICAGO, IL, 60690-2786, US

(73) Assignee: GOEKEN GROUP CORP., Naperville, IL (US)

(21) Appl. No.: 12/813,274

(22) Filed: Jun. 10, 2010

Related U.S. Application Data
(60) Provisional application No. 61/185,678, filed on Jun. 10, 2009.

(51) Int. Cl. H04W 4/22

(52) U.S. Cl. 455/404.2; 455/404.1

(57) ABSTRACT

A system and method for providing emergency response via a wireless link. In a limited and localized coverage area, a plurality of mobile pendant units is provided in communication with a local node and router. The mobile pendant units each include a wireless transceiver for communication with a wireless transceiver of the local node and router. The local node and router includes an interface to traditional networks, such as wired, wireless or satellite, which permits communication between an operations center and one or more of the mobile pendant units. Once one of the mobile pendant units is activated, its location is known and verbal communication is facilitated between the mobile pendant unit, the local node and router, and an operations center, as well as between the mobile pendant units.

### RELATED APPLICATION

This application is the non-provisional filing of provisional application no. 61/185,678, filed Jun. 10, 2009, the disclosure of which is incorporated herein by reference.

### BACKGROUND OF THE INVENTION

This invention relates to providing a response in an emergency situation, and in particular to providing emergency response via a wireless link between mobile pendant units, a local node and router to which the pendant units are wirelessly linked, and an operations center. Particularly, the invention relates to a system and method for providing an emergency response and retrieval of vital information via a limited and localized coverage area that is linked through a typical network to an operations center.

Limited and localized coverage mobile transceiver assemblies, such as cordless telephones, are well known. Such devices utilize one of any number of radio frequency links, and have a limited coverage area. Localized coverage mobile transceiver assemblies typically transmit and receive via a fixed radio network. Typical transceivers are large in size and employ a key pad for actuation and communication purposes. Such assemblies may have a single handset associated with a single base, or multiple handsets that communicate with a main base unit that has the main network interface.

Unless blocked, a typical local coverage mobile transceiver assembly includes caller identification (Caller ID). Caller ID indicates the telephone number or other identification of the caller, but any emergency personnel accessing that information will not know the location of the mobile transceiver assembly.

Emergency notification devices have been developed. The Medical Alert sold by Connect America Medical Alert Company of Broomall, Pa., provides a system including a base and a portable unit. The portable unit functions only in a singular direction, from the portable unit to the base. Upon activation of the portable unit's panic button, the base turns on the base speaker and microphone in order to assist in voice communications between the base and an emergency services provider that has been summoned.

In the event that emergency personnel are dispatched to the location in which the base is situated, medical or any other data is not readily available to the medical personnel, thus putting the user in immediate danger if the user cannot communicate medical information to the responding personnel.

### SUMMARY OF THE INVENTION

The invention includes a system for providing emergency response via a wireless link. It includes a plurality of mobile pendant units, each mobile pendant unit comprising a first wireless transceiver which is configured to receive and transmit radio frequency signals via at least one of multiple radio frequency links in a limited and localized coverage area. It includes at least one trigger to activate the wireless transceiver, and a data input and storage device. A local node and router is provided for the mobile pendant units. The local node and router includes a second transceiver configured to receive radio frequency signals from and transmit radio frequency signals to the first wireless transceivers in the limited and localized coverage area. The local node and router also includes a memory and an interface to a public access point.

In accordance with the preferred form of the invention, the system includes a locator for sensing the location of each mobile pendant unit and for providing that location to the local node and router. The locator comprises a plurality of sensors, each sensor being operatively connected to the local node and router. Preferably each sensor is operatively connected to the local node and router through a mobile pendant unit that is sensed by the sensor.

The trigger comprises a button on the mobile pendant unit operatively connected to the data input and storage device. The trigger includes an SOS trigger and a COM trigger.

Each mobile pendant unit includes a unique identification located in the data input and storage device. Each mobile pendant unit also includes a speaker and microphone for direct and audible communication from the mobile pendant unit.

The local node and router includes a speaker and microphone for verbal communication with the mobile pendant units. It can communicate singly with a mobile pendant unit from which a distress signal has been received, or globally with all mobile pendant units within the limited and localized coverage area in which the local node and router operates.

The interface of the local node and router to a public access point includes a satellite interface, a wireless network interface, and a wired network interface. A sensing router is provided, connected to the satellite, wireless network and wired network interfaces, for selecting one of the interfaces based on availability and, if desired, the least expensive connection.

The data input and storage device of each mobile pendant unit includes a data dongle. The data dongle has stored therein a unique identification for the mobile pendant unit and a controller for its wireless transceiver. Also, the dongle includes a connector for connection of the mobile pendant unit to a data port, whether of its local node and router, or any other computing device including a compatible data port. Preferably, the dongle is pivotable from the mobile pendant unit from a storage orientation to an operable position.

The method according to the invention is for providing a wireless link, where the plurality of mobile pendant units is in the limited and localized coverage area, and the units are operatively connected to the local node and router, with the local node and router being operatively connected to an operations center via a public network access. The method comprises the steps of receiving at the local node and router a distress signal from one of the mobile pendant units. Then, the local node and router determines that a trigger on the mobile pendant unit has been activated. A verbal communication is established between the mobile pendant unit and the local node and router, and the local node and router receives an identity and location of the one of the mobile pendant units sending the distress signal. The local node and router then transmits to the operations center the identity and location of the mobile pendant unit that has sent the distress signal.

The method further includes the step of establishing verbal communication between the mobile pendant unit and the operations center. The method also includes establishing verbal communication between the mobile pendant units sending the distress signal, and the other mobile pendant unit in the limited and localized coverage area.

### BRIEF DESCRIPTION OF THE DRAWINGS

The invention is described in greater detail in the following description of examples embodying the best mode of the invention, taken in conjunction with the drawing figures, in which:

FIG. 1 is an overall outline of the environment of the invention, with the local coverage area and local node and router communicating through the available public network access,

FIG. 2 is a block diagram of the invention showing the inter-relationship of the wireless transceivers of the mobile pendant units to an operations center,

FIG. 3 illustrates, in greater detail, the local node and router and its interfaces,

FIG. 4 illustrates front, back, and side views of a mobile pendant unit according to the invention,

FIG. 5 is a functional block diagram of the mobile pendant unit of FIG. 4,

FIGS. 6 is a block diagram of portions of the mobile pendant unit for uploading information to, and information from, the mobile pendant unit, and

FIG. 7 is a block diagram of the wireless sensor for communication and location of mobile pendant units within a localized area.

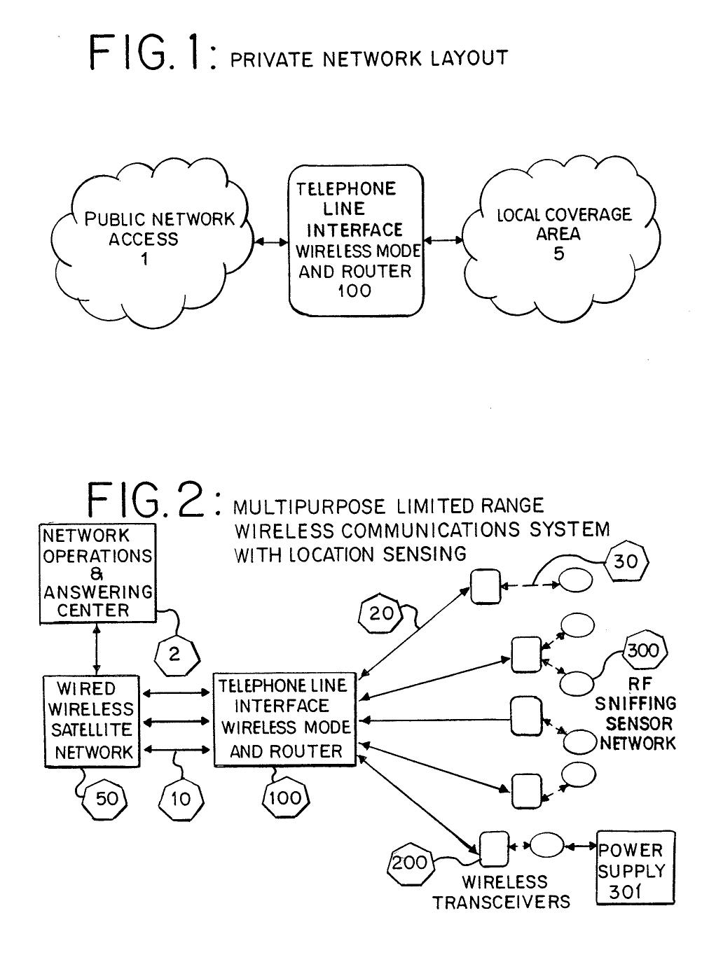

### DESCRIPTION OF EXAMPLES EMBODYING THE BEST MODE OF THE INVENTION

The invention employs a local node and router 100 which communicates with mobile pendant units and other elements in a local coverage area 5. The local node and router 100 also communicates with emergency services, such as at an operations center, via a public network access 1.

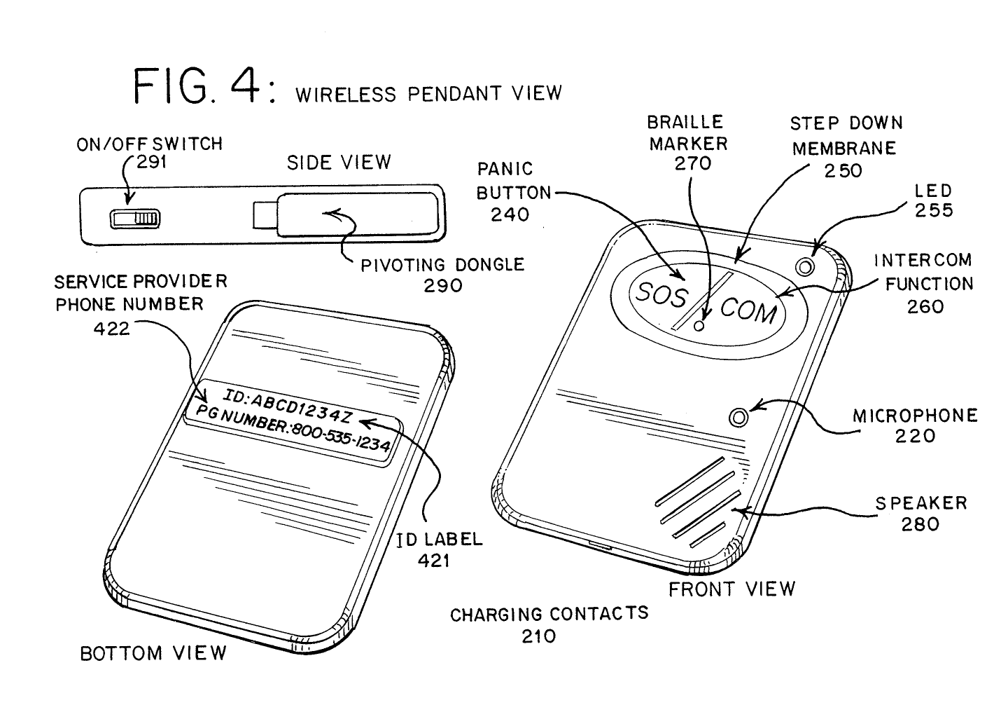

FIG. 2 is a functional block diagram of the invention. The local node and router 100 is used for providing a multi-purpose response to data or voice requests from a plurality of mobile pendant units 200, described in greater detail below in relation to FIGS. 4 through 6. The mobile pendant units 200 communicate wirelessly with the local node and router 100 via wireless links 20. The local node and router 100 is a “node” which interfaces with the mobile pendant units 200, on the one hand, through the wireless links 20, and with an operations center 2, on the other hand, via an appropriate interface to a conventional public access network 50, such as wired, terrestrial wireless, or satellite.

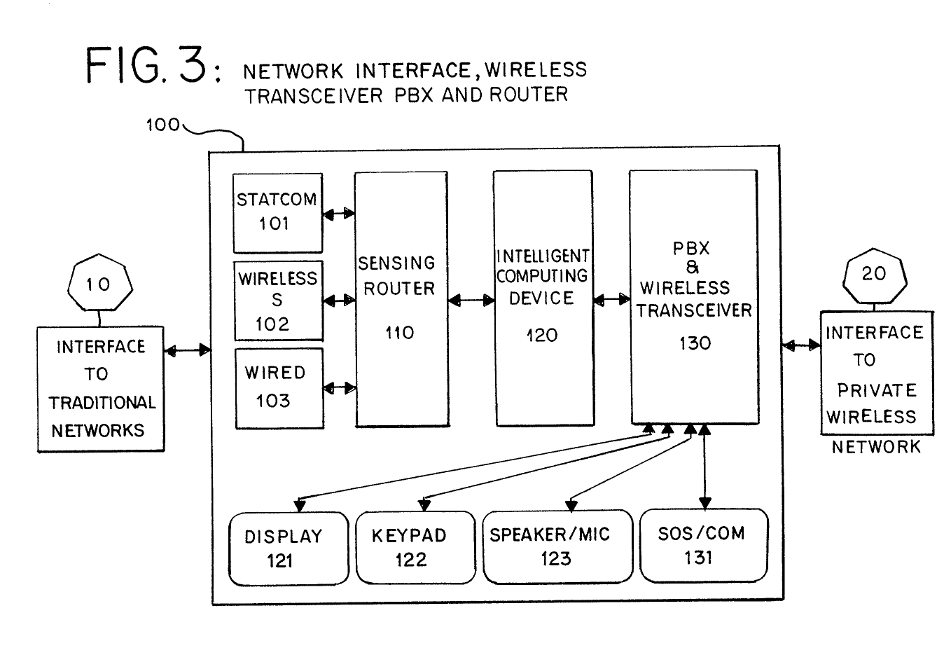

The local node and router 100 provides singular telephone access, PBX functionality, and radio routing. As illustrated in FIG. 3, it includes a display 121, a key pad 122, a speaker and microphone 123 and an emergency or communication button 131, all of which are connected to a PBX and wireless transceiver 130. A computer 120, described in greater detail below, is connected to the transceiver 130 and is also connected to a sensing router 110 which, in turn, is connected to a satellite router 101, a wireless router 102 and a wired router 103. For entry of information to, or down loading of information from the local node and router, a data port 141, such as a USB port is provided.

The transceivers 130, via the wireless links 20, enable wireless communications between the mobile pendant units 200 and emergency personnel, such as police, ambulance, hospital personnel, as well as other users of mobile pendant units 200 within the local coverage area 5. Thus the wireless links 20 may be many conventional types of links between the local mode and router 100 and the wireless transceivers 200 within the limited and local coverage area 5. Typical wireless links include CDMA, GSM, enhanced Blue Tooth, Wi-Fi, Wi-Max, or LTE.

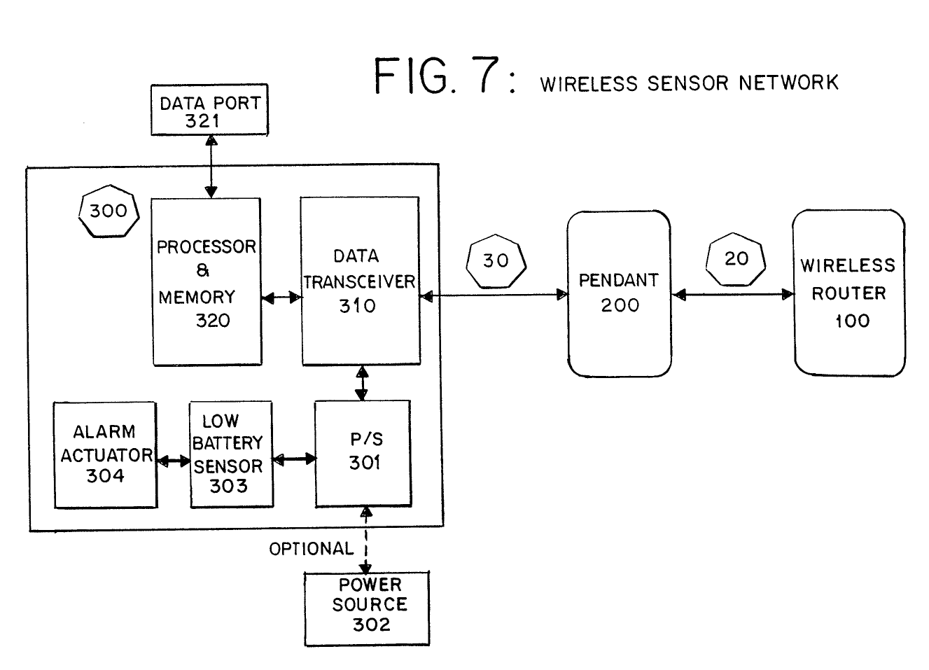

The local coverage area is intended to be limited, such as to a building, complex, or neighborhood. The mobile pendant units are, as their names suggest, mobile within the local coverage area 5. It is therefore important to know the location of each mobile pendant unit 200 should one of the mobile pendant units be activated for providing an emergency response. To this end, ascertaining the location is achieved via a series of sensors 300, disbursed within the local coverage area 5. The sensors are located in predetermined areas and are wirelessly networked by a wireless connection 30 via the mobile pendant units 200 to the local node and router 100. The sensors preferably are very low emission devices which cover only the vicinity of a room or similar area. The sensors function as radio sniffing data devices, each possessing a unique radio identification. For example, sensor I.D. 0010 can be associated with a specific sensor of the sensors 300, and once assigned to a known room, its location is known. Programming of the sensor 300 to its particular room can be achieved before or after installation in that room. Each sensor 300 can be powered via a power supply 301, by battery power, or by an external power source. The sensors are discussed further in relation to FIG. 7.

As each mobile pendant unit 200 roams the local coverage area 5, radio frequency emission from the mobile pendant unit 200 is detected by the sensor 300 in its vicinity. A data communications exchange 30 is established between the sensor 300 and the mobile pendant unit, and is reported, via the wireless link 20, to the local node and router 100. Thus, if the location of a particular mobile pendant unit is desired, the local node and router 100 can be polled for that information, which can then be relayed via the public network access 1 to an operations center 2.

It is preferred that the local node and router be able to communicate via the public network access 1 via any available carrier. Therefore, as described above, the local node and router 100 includes the satellite router 101, the wireless router 102 and the wired router 103. The purpose of the sensing router 110 is to not only sense which public access is available, but also to preferably sense the least expensive carrier at the time that any request is made via the local node and router 100.

The local node and router 100 includes the intelligent computing devise 120, which is the “brains” of the local node and router 100. Among other things, the intelligent computing device 120 executes the function of communications and routing to and from the mobile pendant units 200 on the one hand, and to and from the public access network 1 on the other.

The intelligent computing device 120 also functions to operate the display 121, dial telephone numbers, or program functions (such as medication reminders) via the keypad 122, and communicate either as a regular telephone or access the mobile pendant units 200. By pressing the button 131, a user can communicate with all of the mobile pendant units 200 via the speaker and microphone 123.

A typical mobile pendant unit 200 is illustrated in FIG. 4. A bi-level step down membrane 250 includes two functions, an emergency function via a panic button side 240 and an intercom function via an intercom function side 260. A Braille marker 270 is used to tactilely differentiate between the panic button side 240 and the intercom function side 260 in case the person operating the mobile pendant unit 200 is unable to see the membrane 250.

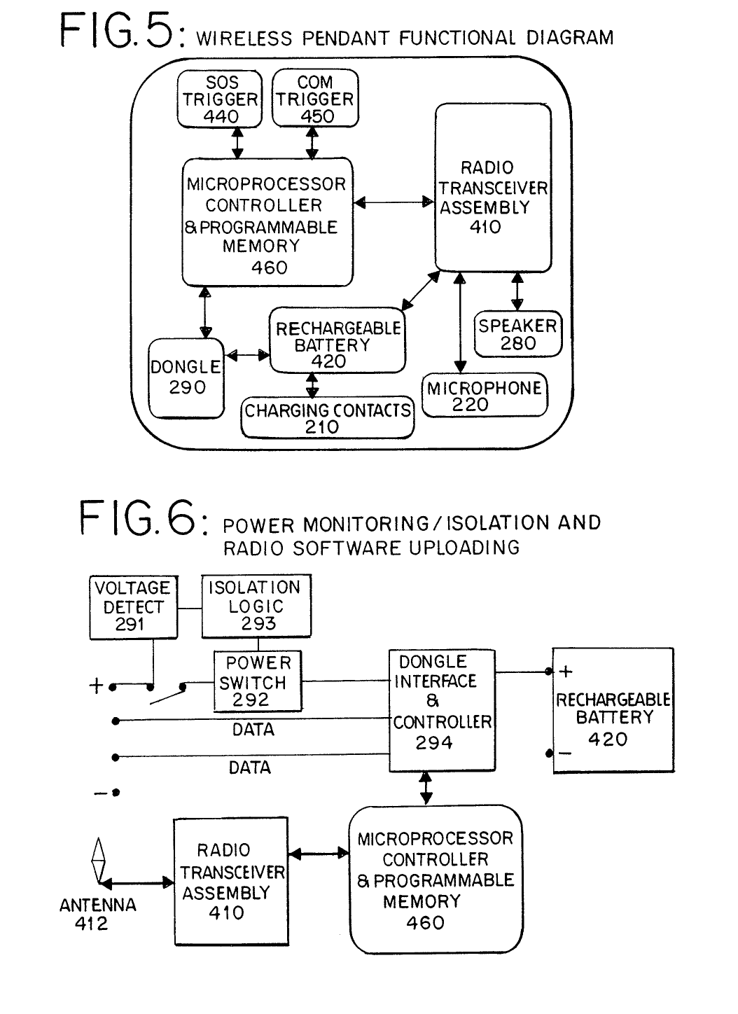

As shown in FIG. 5, depression of the panic button side 240 of the membrane 250 activates an SOS trigger 440. The depression of the intercom function side 260 of the membrane 250 activates a COM trigger 450. The triggers 440 and 450 are connected to a controller and memory 460. The memory 460 is connected to a wireless transceiver 410 which is configured to receive and transmit radio frequency signals via at least one of the multiple radio frequency links 20 in the limited and localized coverage area 5. Thus, via the microphone 220 and speaker 280, the user of the mobile pendant unit 200 can communicate either with other of the mobile pendant units 200, or, via the local node and router 100, with an operations center 2. The mobile pendant unit 200 also includes a multi-color LED 255 to indicate various desired functions, such as the mobile pendant unit 200 being on or off (via the switch 291) or an internal rechargeable battery 420 being low. The mobile pendant unit 200 includes charging contacts 210 for recharging the battery 420.

Each mobile pendant unit 200 is provided with a unique identification associated with the user of the device. Preferably, that identification is provided on an identification label 421 on the back of the mobile pendant unit 200. Also the unique identification is stored for access in the memory 460. If desired, a telephone number for the service provider for emergency services can be located at 422 on the label 421.

The mobile pendant unit 20 includes a pivoting data dongle 290. The dongle includes information for radio control of the radio transceiver assembly 410 as well as unique information about the user of the mobile pendant unit 200, such as medical data. The dongle 290 pivots to allow for insertion into an external computing device for extraction of data information or simply for programming. For example, the dongle 290 may include a USB port for insertion in the data port 141, or in any compatible USB port in any computing device. The dongle 290, as illustrated, is powered by the battery 420 of the mobile pendant unit 200 when the mobile pendant unit 200 is not seated in either a charging device or connected, via the dongle 290, to a data port.

Preferably, the mobile pendant unit 200 includes a unique identification that is stored in the memory 460. Therefore, for security purposes to program information into the mobile pendant unit 200 or receive information from the mobile pendant unit 200, both the unique identification and the ID from the label 421 are used.

With utilization of the dongle 290, programming of the dongle 290 can be accomplished by insertion in the data port 141 or any external programming device, or wirelessly. In FIG. 6, for wireless programming, an antenna 412 is provided in the mobile pendant unit 200, connected to the memory 460 via the radio transceiver assembly 410. If the dongle 290 is inserted in the data port 141 or an external computing device, a voltage detect circuit 291 and power switch 292, via isolation logic 293, connect the power of the external computing device to the dongle 290 and mobile pendant unit 200, thus relieving the battery 420. Downloading of new information from the dongle 290 or uploading of information to the dongle 290 is via the dongle interface and controller 294 connected to the memory 460.

FIG. 7 illustrates a sensor 300 in greater detail. Sensor 300 is wireless and functions as a data transceiver powered by a power source 301, such as a battery, or externally by commercial line power, shown as the power source 302. As explained above, the wireless sensor 300 senses the presence of a mobile pendant unit 200 and if the mobile pendant unit 200 is in the coverage vicinity of the sensor 300. As explained above, the sensor 300 reports its identification information to the mobile pendant unit 200 if the mobile pendant unit 200 is in the area of coverage of the sensor 300. The identification information of the sensor 300 is sent by the wireless link 30 to unit 200 which, in turn, passes that information via the wireless link 20 to the local node and router 100.

The sensor 300 also includes a programmable memory 320 and a data port 321 for loading information into the memory 320, or receiving information from the memory 320. Thus, a particular sensor 300 can be assigned to a specific and pre-defined location within an area which, once programmed in the memory 320, can then be passed by the data transceiver 310 when a mobile pendant unit 200 is encountered. Of course, the port 321 also provides for system software updates, etc.

As with any remote unit, it is advantageous to provide the sensor 300 with means to identify any malfunction or potential malfunction. Therefore, the sensor 300 also includes a low battery sensor 303 which is connected to the power supply 301, which detects a low battery condition if the power source 301 is a battery, or which could detect interruption of the power source, if an external power source. An alarm 304 is connected to low battery sensor 303 to give an audible alarm if such a situation occurs. Just as in FIG. 4, a light such as the multi-color LED 255 can be provided to indicate various conditions of the sensor 300.

The system and method of the invention enable a distressed user of the mobile pendant unit 200 to easily summon rescue personnel either residing in the limited and local coverage area 5 or more broadly through the public network access 1. In addition to dispatching emergency responders to the location of the user of the mobile pendant unit 200, the system also enables verbal communication with a distressed user of the mobile pendant unit 200. Furthermore, the invention enables quick access to medical and other personal information of the user, and, using that information, emergency responders can respond more efficiently. Furthermore, the system enables persons within the local coverage area 5 to be alerted that an emergency is occurring with one of the users of one of the mobile pendant units 200. Accordingly, the system and method provide a multi-purpose emergency response to enable help and instructions to be dispatched to a user quickly and effectively.

Various changes can be made to the invention without departing from the spirit thereof or scope of the following claims.

What is claimed is:

1. A system for providing emergency response via a wireless link, comprising
a. a plurality of mobile pendant units, each mobile pendant unit comprising
i. a first wireless transceiver configured to receive and transmit radio frequency signals via at least one of multiple radio frequency links in a limited and localized coverage area,
ii. at least one trigger to manually activate said wireless transmission, and
iii. a data input and storage device,
b. a local node and router comprising
i. a second wireless transceiver configured to receive radio frequency signals from and transmit radio frequency signals to said first wireless transceiver in the limited and localized coverage area,
ii. a memory, and
iii. an interface to a public access point.

2. The system for providing emergency response according to claim 1, including a locator for sensing the location of each mobile pendant unit and providing the location to the local node and router.

3. The system for providing emergency response according to claim 2, in which said locator comprises a plurality of sensors, each sensor being operatively connected to the local node and router.

4. The system for providing emergency response according to claim 3, in which each sensor is operatively connected to the local node and router through a mobile pendant unit sensed by the sensor.

5. The system for providing emergency response according to claim 1, in which said trigger comprises a button on said mobile pendant unit operatively connected to said data input and storage device.

6. The system for providing emergency response according to claim 5, in which said trigger includes an SOS trigger and a COM trigger.

7. The system for providing emergency response according to claim 1, in which each mobile pendant unit includes a unique identification located in said data input and storage device.

8. The system for providing emergency response according to claim 1, in which each mobile pendant unit includes a speaker and microphone.

9. The system for providing emergency response according to claim 1, in which said local node and router includes a speaker and microphone for verbal communication with said mobile pendant units.

10. The system for providing emergency response according to claim 1, in which interface includes a satellite interface, a wireless network interface, and a wired network interface.

11. The system for providing emergency response according to claim 10, including a sensing router connected to said satellite, wireless network and wired network interfaces for selecting one of said interfaces.

12. The system for providing emergency response according to claim 1, in which each said data input and storage device includes a data dongle.

13. The system for providing emergency response according to claim 12, in which said dongle includes a unique identification for the mobile pendant unit and a controller for said first wireless transceiver.

14. The system for providing emergency response according to claim 12, in which said dongle includes a connector for connection of said mobile pendant unit to a data port.

15. The system for providing emergency response according to claim 12, in which said dongle is pivotable from said mobile pendant unit.

16. A method of providing emergency response via a wireless link, where a plurality of mobile pendant units in a limited and localized coverage area is operatively connected to a local node and router, and the local node and router is operatively connected to an operations center via a public network access, the method comprising the steps of
a. receiving at the local node and router a distress signal from one of said mobile pendant units,
b. determining by the local node and router that a trigger on said mobile pendant unit has been activated.
c. establishing verbal communication between said mobile pendant unit and said local node and router,
d. receiving at said local node and router an identity and location of said one of said mobile pendant units, and
e. transmitting from said local node and router to the operations center the identity and location of said one of said mobile pendant units.

17. The method according to claim 16, including the further step of establishing verbal communication between said mobile pendant unit and said operations center.

18. The method according to claim 16, including the further step of establishing verbal communication between all mobile pendant units and the one mobile pendant unit that has been activated.
